(19) United States
(12) Patent Application Publication
(10) Pub. No.: US 2006/0145487 A1
(43) Pub. Date: Jul. 6, 2006

(54) Universal door striker plate that permits continuous adjustment

(76) Inventor: Winston Y. Wilder, Dallas, TX (US)

Correspondence Address: CHALKER FLORES, LLP, 2711 LBJ FRWY, Suite 1036, DALLAS, TX, 75234, US

(21) Appl. No.: 11/293,004

(22) Filed: Dec. 2, 2005

Related U.S. Application Data
(60) Provisional application No. 60/633,118, filed on Dec. 3, 2004.

(51) Int. Cl. E05B 15/02

(52) U.S. Cl. 292/340

(57) ABSTRACT

The present invention is an apparatus and method for increasing the security of a door latch that uses a striker plate having a striker plate housing with at least one opening, one or more pins positioned slidably and toward an opening in the striker plate housing and a biasing mechanism in contact with the one or more pins for biasing each of the one or more pins toward the opening to conform to the shape of a throw bolt inserted into the opening.

### CROSS-REFERENCE TO RELATED APPLICATIONS

This application claims priority to U.S. Provisional Application Ser. No. 60/633,118, filed Dec. 3, 2004, the contents of which are incorporated by reference herein in their entireties. Without limiting the scope of the invention, its background is described in connection with door hardware, as an example.

### TECHNICAL FIELD OF THE INVENTION

The present invention relates generally to door hardware, and in particular, to an adjustable door striker plate that does not require continuous adjustment.

### BACKGROUND OF THE INVENTION

A conventional doorframe includes a door passageway, which is typically made of a pair of studs (e.g., wooden 2 by 4 studs nailed together or metal studs) covered by a casing made of ¾ of an inch boards, or metal casings in many commercial applications, forming a door jam. The door is hinged on one side of the housing with a doorknob and a door latch on the other side. The doorjamb leaves tight tolerances on all sides providing little space between the door and the door jam, yet still allows the door to function freely.

The door is secured into position with a door latch, which extends from the door and penetrates a hole, one-inch in diameter, in the casing and studs of the doorframe. The hole is aligned with the door latch and covered with a striker plate. The striker plate is generally 2 to 3 inches in length, made of metal and mortised and screwed into the casing of the door with ½ to ¾ of an inch long screws, which are easily stripped out. As a result of the tight tolerances and modification of the casing the installation of the striker plate is a customized operation. Therefore, the striker plate is difficult to reposition once it is installed. For the door and lock to function properly the door latch must fit into the hole of the striker plate. Misalignment of the door latch, the strike plate or both may result in serious security, health and safety risks in a door that will not close or open, latch or secure correctly.

As a consequence of age, humidity, foundation shifting and/or weather conditions buildings may move and cause doorframes to shift up and down and side to side. This movement results in misalignment of the relatively small hole of the striker plate and the door latch and/or the dead bolt latch. The misalignment often causes the door to be difficult or even impossible to secure. Additionally, the movement of the housing may result in the latch entering partially the striker plate and as a result may not adequately secure the door. In instances where the striker and door latch are semi-aligned, the interaction may be such that the friction is not sufficient to hold the door secure at such an imperfect position. In addition to the serious security problem caused by the misalignment, repeated attempts to reposition the striker plate may serious weaken the integrity of the doorframe and alter the aesthetic look of the door. Furthermore, even when the striker plate is moved, changes in conditions often cause the latch to return to its original position, causing the latch to misalign once again. Such changes are often observed and associated with changes in humidity.

One solution to the misalignment of the door latch and the hole of the striker plate includes the use of force (e.g., to pull the door up or push the door down or slam the door) to make the door latch and the striker plate hole align. Often doors that are forced to align result in doors that are just as difficult to reopen due to binding of the door, door latch, striker plate, or combination thereof. This problem is exacerbated when dealing with the elderly, children or the disabled, as they may not have the strength or the dexterity to supply the required force to align the door latch and striker plate hole. Furthermore, in times of emergency (e.g., a fire) a misaligned door and a lack of strength may preclude escape or cause the door to open during, e.g., a fire.

Other solutions to misalignments include adjusting the striker plate by redrilling the screw holes and remortising the striker plate to accommodate the new alignment position; most often resulting in the marring or destruction of the doorframe. Furthermore, reoccurring movement of the doorframe results in the process being repeated periodically, resulting in weak unsightly door jams.

The structure of a deadbolt latch and a door latch are quite different. The deadbolt has a larger diameter and a generally rectangular shape, which requires a matching striker plate hole. A door latch has a shorter, more rounded shape and corresponding striker plate. To further compound issues, some manufactures are designing door latches that incorporate the size and shape of the deadbolt latch. To change between these types new striker plates must be installed, which involves redrilling the screw holes and remortising the striker plate, often resulting in the marring or destruction of the doorframe.

The foregoing problems have been recognized for many years and while numerous solutions have been proposed, none of them adequately address all of the problems in a single device, e.g., multiple adjustments without reboring or remortising the doorjamb.

### SUMMARY OF THE INVENTION

The present inventors recognized a need for a striker plate that would accommodate various vertical and horizontal alignments for receiving a door latch or a deadbolt latch, while eliminating the need to rebore the door jam and remortise the striker plate to correct misalignments.

In accordance with the present invention, a method and apparatus are provided that accommodate various vertical and horizontal alignments for receiving a throw bolt, a door latch, a deadbolt latch or any other securing mechanism. The present invention provides various vertical and horizontal alignment positions for receiving a throw bolt (e.g., door latch or a deadbolt latch), while eliminating the need to rebore the door jam and remortise the striker plate to correct misalignments.

For example, the present invention includes a striker plate having a striker plate housing with at least one opening, one or more pins positioned slidably and toward the opening of the striker plate housing and a biasing mechanism in contact with the one or more pins for biasing each of the one or more pins toward the opening to conform to the shape of a throw bolt inserted into the opening. In one embodiment, the pins form an array of pins.

The present invention also provides a method for securing a door including the steps of positioning a striker plate housing adjacent to a throw bolt and inserting the throw bolt into the striker plate. The striker plate housing includes at least one opening, one or more pins positioned slidably and toward the opening of the striker plate housing and a biasing mechanism in contact with the one or more pins. The biasing mechanism biasing each of the one or more pins toward the opening to conform to the shape of a throw bolt inserted into the opening. When the throw bolt is inserted into the striker plate at least a portion of the one or more pins are depressed, whereby the throw bolt is retained.

The throw bolt may be of the general shape of a bolt, square, rectangle, oval or tube that may be inserted into the opening. For example, the throw bolt may include a throw bolt, dead bolt, circular bolt, dustless bolt, rod bolt, gate bolt, pin bolt, slide bolt, peg, rod, nail, pin, bolt array, pin array, array or a bolt. The throw bolt may be inserted into the opening and as a result forces one or more pins away from the throw bolt. The throw bolt may be hollow or partially hollow to allow one or more of the pins to penetrate the throw bolt. The present invention provides the use of various types of throw bolts having different lengths, widths and shapes; as a result the present invention may dimensions that accommodate such a lengths, widths, depths and shapes. The dimensions of the present invention do not have to be proportional to the lengths, widths, depths or shape of the throw bolt. For example, the present invention may be 4 inches in depth for a 1 inch throw bolt; however, the present invention may be 1, 2, 3, 4, 5, 6, 7, 8, 9, 10 inches in lengths, widths, depths or combinations thereof. The present invention may also be varied by portion of inches for specific applications, e.g., ±0.1, 0.2, 0.3, 0.4, 0.5, 0.6, 0.7, 0.8, 0.9, 1.0.

The striker plate may be mounted to the door in many different manners depending on the particular application. The striker plate may be mounted as a conventional striker plates within the door casing, door jam and doorframe with screws bolts or other fasteners securing it in place. For other applications, the striker plate may be mounted behind the door casing and wall, with only the opening being exposed. The striker plate may be attached through screws into the studs of the frame or with fasteners through the housing and into the doorframe, whereby no fasteners are visible when installed. Additionally, the striker plate may be fitted into a receiving member attached to the doorframe or doorjam designed to hold the striker plate, thus, allowing a premade aperture for the striker plate. Additionally, the present invention may be incorporated into a prefabricated stud or door jam or as part of a prefabricated insert. The striker plate may also be attached to the exterior of a surface, e.g., a gate, fence, or door, using, e.g., straps. The striker plate maybe attached using fasteners through the surface and into the back of the housing, providing added security through concealing the attachment mechanisms. In addition, the present invention may be attached to a plate attached to the doorjam using a lip and groove, clip, a weld or bond or using similar mechanisms, e.g., the present invention snaps into a holder or striker plate that is then attached to the door. For example, the present invention may include a cover that extends around the doorjam covering a portion of the interior surface, exterior surface or both, whereby the cover provides additional protection and support. Other attachment mechanism that may be used including attachment straps, metal straps, epoxy, glue, welding or similar mechanism.

The present invention is also useful for placement on truck beds, commercial trailers, covered trailers, vehicle doors, hoods, storage building entrances and similar openings. The present invention may be inserted into the structure and positioned to allow a throw bolt to penetrate the opening and thus securing the enclosure.

One embodiment of the present invention is designed to fit a throw bolt; however, other embodiments are designed to fit more than one throw bolts. The housing may be extended to a size to accommodate throw bolts of different sizes, shapes and positions. The multiple throw bolts may be of the same type or of different types, having different widths, lengths, compositions, and the like.

The one or more pins of the present invention include an elongated middle portion and a first and second end, wherein one or more retaining mechanisms are positioned at a first end, a second end, in the middle portion, or combinations thereof, of each of the one or more pins. The one or more pins may individually be similar or different in size, shape, composition or texturing. The one or more pins may have a cross section that is circular, oval, square, rectangular, triangular, polygonal or combinations thereof.

The present invention uses one or more pins positioned slidably and toward the opening of the striker plate housing. The one or more pins may be arranged generally parallel to each other and extend toward the opening at an angle of between about 0 to 90 degrees. The pin may have one or more regions for retaining the pin within the housing and a bias mechanism. In some embodiments, the bias mechanism is positioned between the one or more retaining mechanism portioned at one end of each of the one or more pins. The present invention provides a biasing mechanism in contact with the one or more pins. The biasing mechanism may include one or more bias mechanisms for each pin. One embodiment may have one or more bias mechanisms for the apparatus. The bias mechanism may also have redundant mechanism, multiple springs, multiple overlapping springs, different types of bias mechanisms in one housing or other configurations. The biasing mechanism may include a coiled compression spring, a coiled compression spring surrounding each of the one or more pins and the like. The bias mechanism can be a compressible medium, an elastomeric medium, a resilient medium or combinations thereof.

The housing of the present invention may have one or more cavities, tunnels, grooves, sheaths, coverings or other mechanism to separate some or all of the one or more pins from each other. The separation will minimize the interaction between pins that may cause failure. The cavity may extent into the housing away from the opening to accommodate the movement of the pin. In some embodiments, the bias mechanism may be positioned between the end of the pin and the cavity. In other embodiments, the bias mechanism may be positioned in contact with the middle of the pin. While in other embodiments, the pin and bias mechanism may both be positioned in multiple locations.

The present invention also includes a method of securing a door including positioning a striker plate housing having at least one opening, one or more pins positioned slidably and toward the opening of the striker plate housing and a biasing mechanism in contact with the one or more pins for biasing each of the one or more pins toward the opening to conform to the shape of a throw bolt inserted into the opening. The striker plate is positioned adjacent to a throw bolt and the throw bolt is inserted into the self-adjusting striker plate, wherein at least a portion of the one or more pins are depressed and the throw bolt is retained.

The present invention also provides a method of making a striker plate including creating one or more holes in a striker plate housing, positioning slidably and toward the opening of the striker plate housing and contacting the one or more pins with a biasing mechanism for biasing each of the one or more pins toward the opening of the striker plate housing.

### BRIEF DESCRIPTION OF THE DRAWINGS

For a more complete understanding of the features and advantages of the present invention, reference is now made to the detailed description of the invention along with the accompanying figures and in which:

FIG. 1 illustrates certain features of a striker plate according to an embodiment of the present invention in operation;

FIG. 2 is a view of another embodiment of the apparatus shown in FIG. 1 in use;

FIG. 3 is a view of certain features of the apparatus shown in FIG. 1;

FIGS. 4a-d are front views of different embodiments of the apparatus shown in FIG. 1;

FIG. 5 is a perspective view that illustrates certain features of a striker plate shown in FIG. 1;

FIG. 6 is a perspective view that illustrates certain features of a striker plate according to another embodiment of the present invention;

FIG. 7 is a perspective view that illustrates certain features of a striker plate according to yet another embodiment of the present invention;

FIG. 8 is a front view of one embodiment of a portion of the apparatus shown in FIG. 1;

FIG. 9 is a front view of another embodiment of a portion of the apparatus shown in FIG. 1;

FIG. 10 is a front view of another embodiment of a portion of the apparatus shown in FIG. 1;

FIGS. 11a-d are side views of different embodiments of one pin of the apparatus shown in FIG. 1;

FIG. 12 is a side view of the apparatus shown in FIG. 1;

FIG. 13 is a side view of the apparatus shown in FIG. 1 in use;

FIG. 14 is a side view of another embodiment of the apparatus shown in FIG. 1;

FIG. 15 is a side view of another embodiment of the apparatus shown in FIG. 1;

FIG. 16 is a front view of a portion of the apparatus shown in FIG. 1;

FIGS. 17a-g are side views of different embodiments of the pins shown in FIG. 1, coupled to a bias mechanism; and

FIG. 18 illustrates certain features of a self-adjusting striker plate in use according to an embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The terminology used and specific embodiments discussed herein are merely illustrative of specific ways to make and use the invention and do not delimit the scope of the invention.

In accordance with the present invention, a method and apparatus are provided that allows self adjusting of a striker plate used for door latches, deadbolts and other latch type locking systems. The present invention provides self adjusting of a striker plate that allows the latch to align with the hole in the striker plate, while accounting for misalignments or movement without the need to adjusting the striker plate by redrilling the screw holes and remortising the striker plate to accommodate the new alignment position.

For example, the striker plate of the present invention is designed as a new or replacement striker plate that alleviates the need to adjusting the striker plate manually by redrilling the screw holes and remortising the striker plate to accommodate the new alignment position. The striker plate is designed to replace conventional door strikers in commercial, residential, storage units and any other area employing a bolt type locking system. The striker plate of the present invention has many embodiments depending on the particular application. One embodiment has a housing that is generally about one and a half inches in width and one and a half inches to two inches in height. The residential applications may have a housing that is generally circular with a diameter of about one to two inches although other designs may be used that accommodate both a door latch, a deadbolt or both.

A semicircular housing may be attached to the outside of a casing, on a commercial trailer or similar application. The sizes of the housing may be altered to accommodate multiple locks. Additionally, the mounting of the striker plate may be accomplished in a variety of ways. The striker plate of the present invention may have a conventional two-hole mounting system with screws penetrating the casing and the doorframe. Alternatively, a four-hole system may be used securing the apparatus at four locations in the casing and the doorframe.

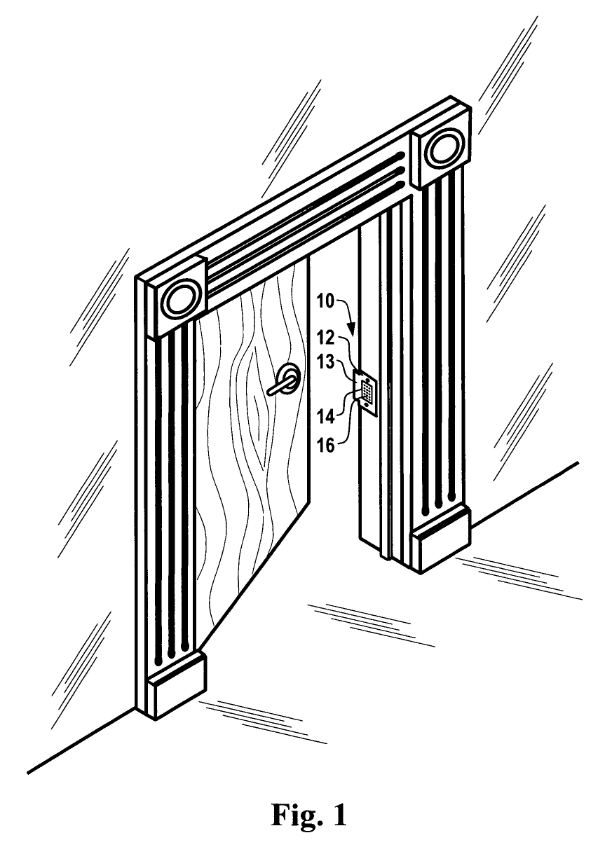

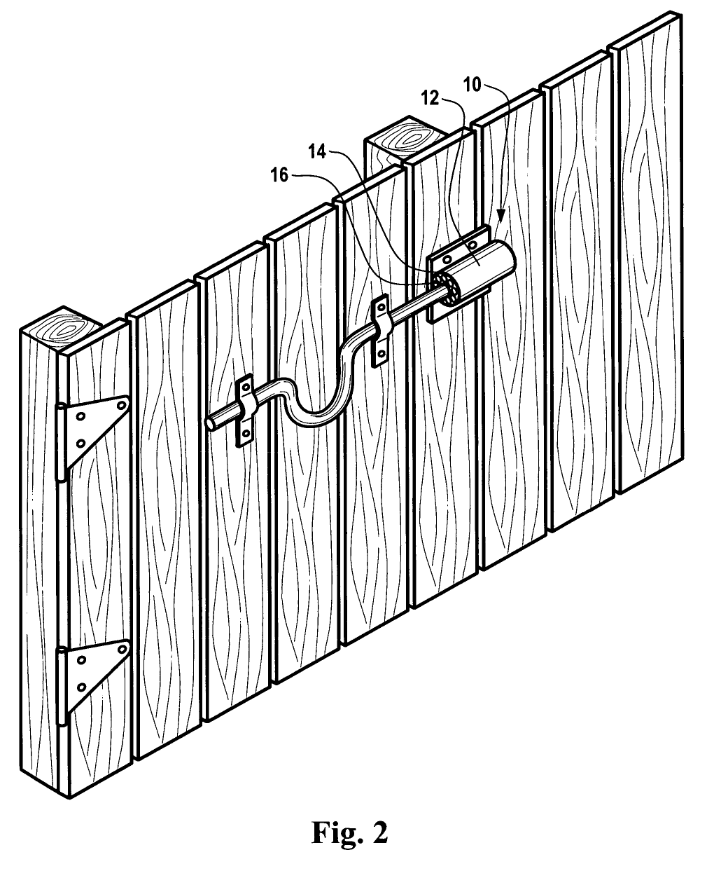

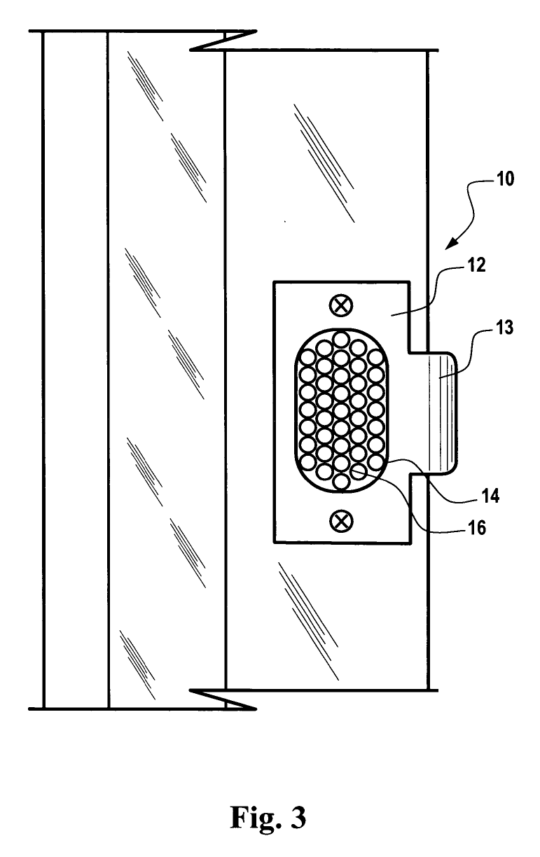

With reference to FIGS. 1, 2 and 3 are views of different embodiments of the self-adjusting striker plate 10 in use. FIG. 1 depicts the striker plate 10 mounted internally in the doorframe of a conventional door opening. FIG. 2 depicts an external attachment of the self-adjusting striker plate 10 to a fence and gate opening. FIG. 3 is a view of one embodiment of the striker plate 10 mounted internally in the doorframe of a door opening. FIGS. 1, 2 and 3 include a housing 12 having an internal region (not shown) and an open end 14 exposing one or more pins 16. For example, the one or more pins 16 form a face of the open end 14 that is generally flush. A lip 13 is incorporated into the housing 12 at open end 14 and directs or pushes the latch toward the opening 14. The one or more pins 16 are packed generally in parallel, however, the arrangement of the pins may be in different configurations (e.g., staggered, spaced, alternating, etc.) depending on the specific application. The one or more pins 16 may be made different lengths, widths shapes and thicknesses depending on the requirements of the particular application.

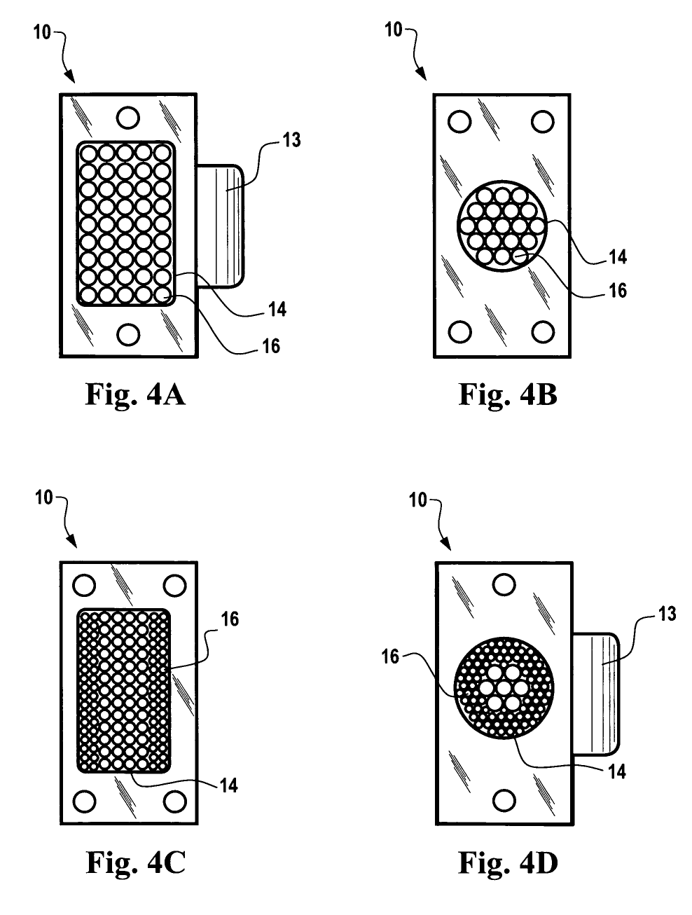

FIGS. 4a, 4b, 4c and 4d are front views of different embodiments of the self-adjusting striker plate 10. The housing 12 has an open end 14 exposing one or more pins 16. A lip 13 is incorporated into the housing 12 at open end 14 and directs or pushes the latch toward the opening 14. FIG. 4a and FIG. 4b are front views of different embodiments of the striker plate 10 having one or more pins 16 made of different materials in the same striker plate 10. For example, steel may be used for the one or more pins 16 closer to the edge or the threshold to maximize their mechanical strength, whereas one or more pins 16 made of plastic may be used in the interior or middle portions to eliminate noise. FIG. 4c and FIG. 4d are front views of different embodiments of the striker plate 10 having one or more pins 16 of differing sizes.

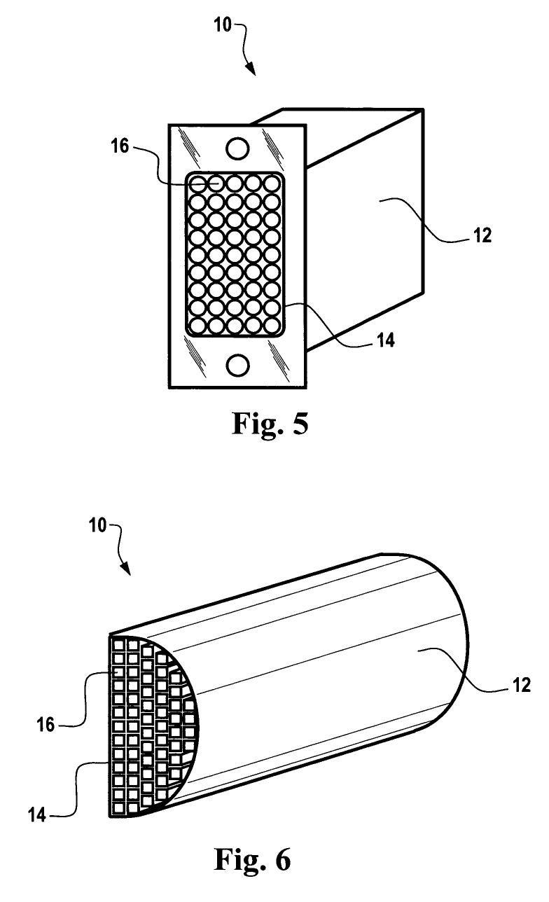

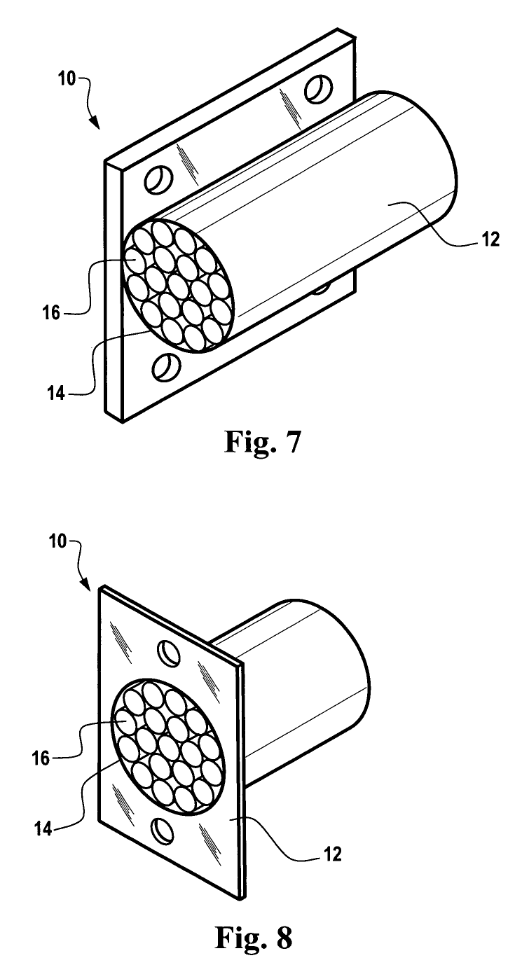

With reference to FIGS. 5, 6 and 7 are perspective views of different embodiments of the striker plate 10. FIG. 5 is a perspective view of an internally mounted striker plate 10 of the present invention. FIG. 6 is a perspective view of an externally mounted striker plate 10, which attaches the housing 12 to a surface. FIG. 7 is a perspective view of an externally mounted self-adjusting striker plate 10 with external mounting straps. FIGS. 5, 6 and 7 are shown and include a housing 12 having an internal region (not shown) and an open end 14 exposing one or more pins 16. The one or more pins 16 are packed generally in parallel, however the arrangement of the pins may be in different configurations (e.g., staggered, spaced, alternating, etc.) depending on the specific application. The one or more pins 16 may be different lengths and thicknesses depending on the requirements of the particular application. The one or more pins 16 form a face of the open end 14 that is generally flush.

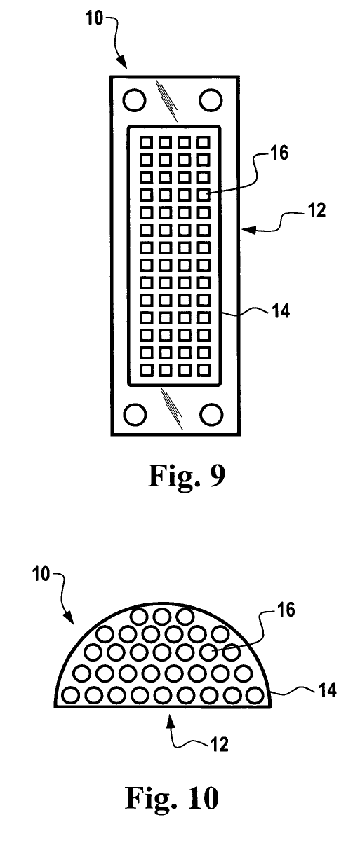

FIGS. 8, 9 and 10 are front views of different embodiments of the striker plate 10 shown if FIG. 1. FIG. 8 is an embodiment having a round opening at open end 14 with a lip 13 that directs or pushes the latch toward the opening 14. The striker plate 10 including the housing 12 having an open end 14 exposing one or more pins 16. The one or more pins 16 have a cross section that is generally circular. FIG. 9 is an embodiment having a square opening at open end 14. The striker plate 10 including the housing 12 having an open end 14 exposing one or more pins 16. The one or more pins 16 have a cross section that is generally rectangular. FIG. 10 is an embodiment having a partial round opening at open end 14. The striker plate 10 including the housing 12 having an open end 14 exposing one or more pins 16 having a cross section that is generally polygonal. The one or more pins 16 and the housing 12 may be made out of metals, alloys, polymers, plastics, wood or other suitable materials or combinations thereof.

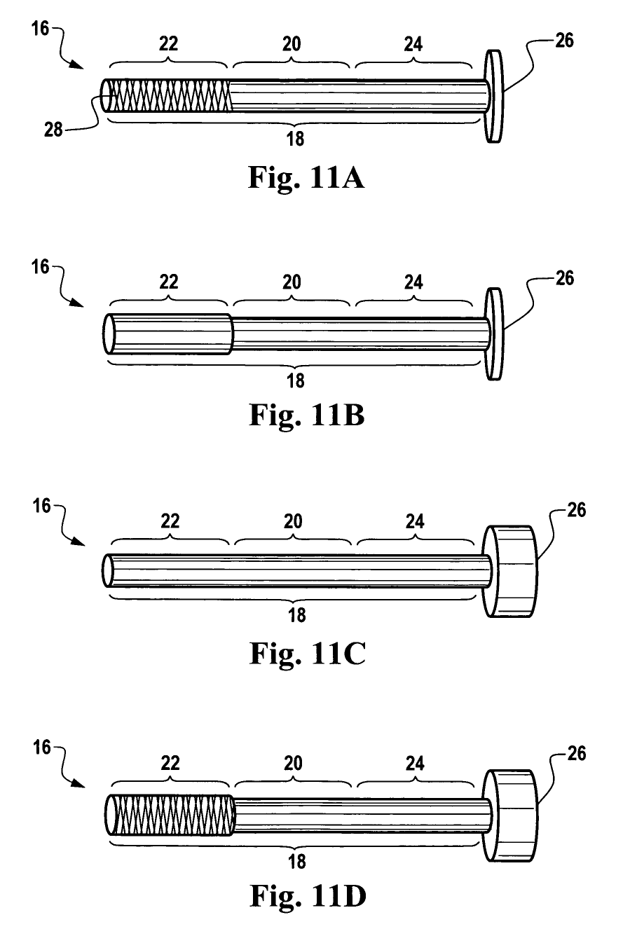

With reference to FIGS. 11a, 11b, 11c and 11d are side views of different embodiments of a portion of the apparatus 10 shown in FIG. 1. A representative pin of one of the one or more pins 16 of a striker plate (not shown) is illustrated. Each of the one or more pins 16 includes a shaft 18 having a middle portion 20, a first end 22 and a second end 24. The second end 24 may have a retaining mechanism 26. In some embodiments, the retaining mechanism 26 may be an enlargement of the second end 24 while other retaining mechanisms may include a removable mechanisms attached to the interior end 24, e.g., a cap, a plate, a notch, a bolt, a clip, a bulge or similar mechanism known in the art. The retaining mechanism 26 serves to retain each of the individual pins of the one or more pins 16 within the housing 12 and in some embodiments provides a coupling location for the bias mechanism (not shown).

In FIG. 11a, the first end 22 may even have a texture region 28. The texture region 28 may have etching, grooves, slots, ribs, beads, coatings, particles, a knurled pattern or combination thereof to provide improved grip by increasing the friction between the contact surfaces of adjacent pins of the one or more pins 16. The texture region 28 may extend partially or entirely over the shaft 18. Additionally, striker plate 10 may contain a variety of pins within the one or more pins 16 with some having the texture region 28, some lacking the textured regions 28, some of different types of texture region 28 or combinations thereof. Additionally, the cross sectional shape of the individual pins of the one or more pins 16 may differ depending on the application. The cross-section may be circular, rectangular, oval, square, polygonal or combinations thereof.

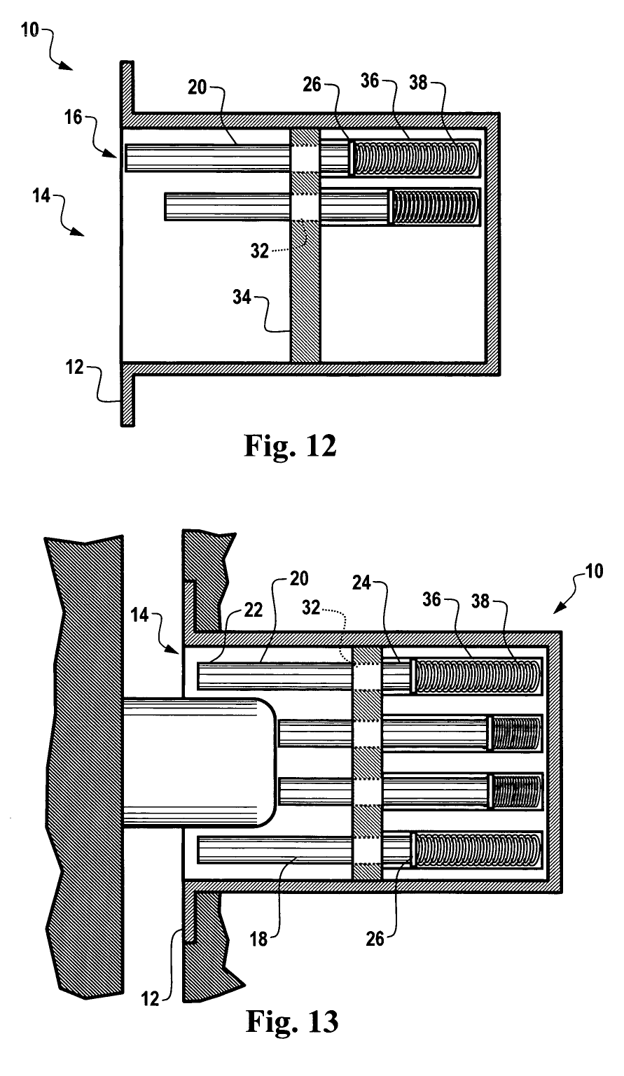

Now referring to FIGS. 12, 13 and 14 different embodiments of a simplified illustration of FIG. 1 insofar as fewer pins are illustrated for the sake of clarity.

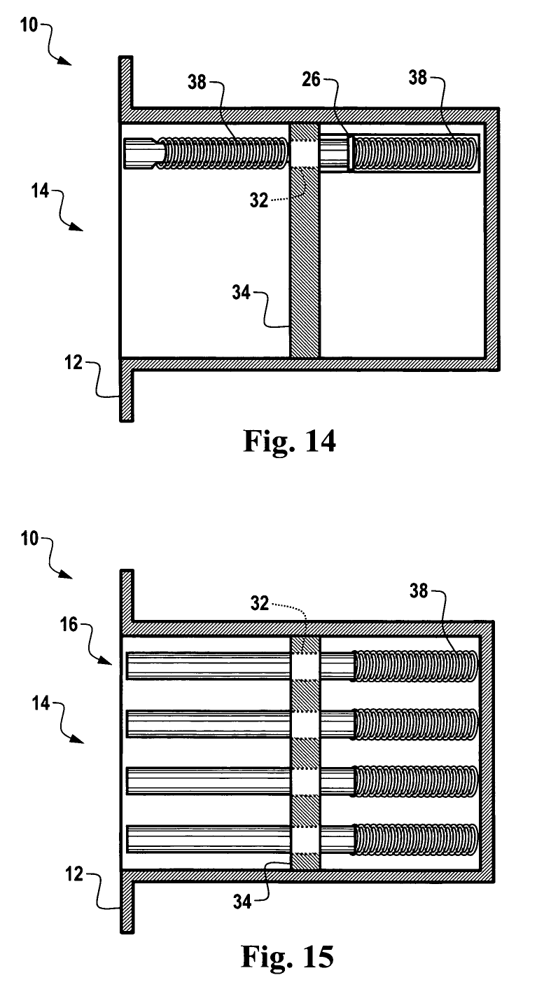

FIG. 12 is a side view of the striker plate 10 having one bias mechanism 38. FIG. 13 is a side view of the striker plate 10 having one bias mechanism 38 and engaging a throw bolt. Whereas, FIG. 14 is a side view of the striker plate 10 having dual bias mechanisms 38. FIGS. 12, 13 and 14 are a simplified view of the striker plate 10 including a housing 12 having an internal region 30 and an open end 14 exposing one or more pins 16. The one or more pins 16 are independently, slidably positioned to penetrate within the housing 12. Each pin of the one or more pins 16 has a shaft 18 having a middle portion 20, a first end 22 and a second end 24. The first end 22 of the one or more pins 16 extends to the open end 14. While the middle portion 20 of the shaft 18 extends into the internal region 30 and through housing aperture 32 of frame 34. The second end 24 of the one or more pins 16 extends into the internal region 30 of the housing 12 and has a retaining mechanism 26 located thereon.

Again refereeing to FIGS. 12, 13 and 14 the retaining mechanism 26 serves to retain the second end 24 of each of the one or more pins 16 on one side of the frame 34 through having a diameter larger than the housing aperture 32, whereby the second end 24 cannot pass through the housing aperture 32. Frame 34 is attached to the internal region 30 of the housing 12. The frame 34 may be a plate fitted to the housing 12 having one or more housing apertures 32. The one or more housing apertures 32 receive the corresponding one or more pins 16 allowing the one or more pins 16 to be arranged in the desired pattern depending on the particular application. The housing aperture 32 is generally the diameter of the middle section 20 of the shaft 18, however other embodiments may use housing aperture 32 of different sizes.

As seen in FIGS. 12, 13 and 14 the frame 34 may be an integrated portion of the housing 12 having one or more housing apertures 32 that create cavities 36 to accommodate the one or more pins 16, whereby each pin of the one or more pins 16 is separated and may move independently of each other pin in the one or more pins 16. The cavities 36 are recessed areas in the frame 34 to accommodate the movement of the one or more pins 16. The frame 34 may alternatively have sheaths or sleeves to fit into the one or more housing apertures 32 to form cavities 36 to accommodate the movement of the one or more pins 16. The sheaths or sleeves may be used to isolate the interaction of the individual pins of the one or more pins 16. The frame 34 may be permanently attached to the housing (e.g., molded, cast, welded, riveted, glued or similarly affixed) or removably affixed (e.g., screwed, riveted, fitted frictionally or similarly held) to the housing 12. A bias mechanism 38 is positioned to contact the each pin of the one or more pins 16. In one embodiment, the one or more pin 16 itself may be made or include a spring, coiled compression spring, comprisable material, elastomeric material, polymeric material, resilient material or combinations thereof.

As demonstrated in FIG. 12, the bias mechanism 38 is fitted into the cavities 36 of the frame 34 so that the bias mechanism 38 contacts the retaining mechanism 26 of the second end 24 of each of the one or more pins 16. In some embodiments, the bias mechanism 38 is separated from other bias mechanism 38 by the cavities 36, sheath or sleeve to allow independent operation of the one or more pins 16. Other embodiments include a bias mechanism 38 that does not have dividers or cavities to separate the individual bias mechanism 38 and/or the one or more pins 16.

Now referring to FIG. 13, a side view of the striker plate 10 having one bias mechanism 38 and engaging a throw bolt in operation. A throw bolt is extended into the open end 14 of the striker plate 10. As the throw bolt is extended into the one or more pins 16, a force is applied to the first end 22 of one or more of the one or more pins 16. The movement of one or more of the one or more pins 16 results in the middle portion 20 of the shaft 18 sliding through the housing apertures 32 toward the second end 24 and each into cavities 36. The arrangement of the one or more pins 16 allows the movement of each pin of the one or more pins 16 independently, e.g., one pin 16 may have force acting on it while the adjacent pin 16 does not, thus one pin 16 moves while the other pin 16 remains stationary. The sliding of one or more of the one or more pins 16 into cavities 36 results in compression of the bias mechanism 38. The one or more pins 16 surrounding the throw bolt are not depressed, as there is no force acting on them and they remain biased away from the frame 34 by the bias mechanism 38. The remaining one or more pins 16 surrounding the door latch or deadbolt cause the door latch or deadbolt to be wedged inside the one or more pins 16. When force is applied to the door latch or deadbolt surrounded by the one or more pins 16 the force is transferred to the adjacent pins of the one or more pins 16 and into the housing 12 and the doorframe, thus resisting movement. When the force is removed, the bias mechanism 38 decompresses, which results in the middle portion 20 of the shaft 18 sliding through the housing apertures 32 toward the open end 14, until the movement of the shaft 18 is stopped by the contact of the retaining mechanism 26 and the housing 32.

FIG. 14 demonstrates another embodiment of the striker plate 10 including a housing 12 having an internal region 30 and an open end 14 exposing one or more pins 16. Each pin of the one or more pins 16 has a shaft 18 having a middle portion 20, a first end 22 and a second end 24. The one or more pins 16 are independently slidably positioned to penetrate within the housing 12. The first end 22 of the one or more pins 16 extends to the open end 14. The first end 22 of the one or more pins 16 including a region of greater diameter than the middle portion 20 of the shaft 18. While the middle portion 20 of the shaft 18 extends into the internal region 30 and through housing aperture 32 of frame 34. The second end 24 of the one or more pins 16 extends into the internal region 30 of the housing 12 and has a retaining mechanism 26 located thereon.

Again referring to FIGS. 12, 13 and 14, the retaining mechanism 26 serves to retain the second end 24 of the shaft 18 on one side of the frame 34 through having a portion of second end 24 have a greater diameter than the housing aperture 32, whereby the second end 24 cannot pass through the housing aperture 32. The retaining mechanism 26 may be an integrated portion of second end 24, e.g., grooves, slots, ribs, beads, particles, notches, bulges or similar mechanism known in the art. Alternatively, the retaining mechanism 26 may be attached to a portion of the second end 24, e.g., a cap, a plate, a bolt, a clip, or similar mechanism known in the art. The attachment may be through a permanent mechanism (e.g., glue, epoxy, weld or the like) or a frictional fitting. The frame 34 is attached to the internal region 30 of the housing 12.

The frame 34 may be a plate fitted to the housing 12 having one or more housing apertures 32. Alternatively, the frame 34 may be an integrated portion of the housing 12 having one or more housing apertures 32 to accommodate the one or more pins 16. The housing apertures 32 may be arranged in different configurations depending on the particular application.

In some embodiments, the housing apertures 32 are separated from other housing apertures 32 in channels or cavities 36, which are void regions that extend the aperture into a the housing material to accommodate the shaft 18 thus allowing independent operation of the one or more pins 16. The cavities 36 structure may include many different structures known to persons of ordinary skill in the art including channels, tunnels, sheaths, sleeves and the like. A bias mechanism 38 is positioned to contact the first end 22 of the one or more pins 16 and the frame 34, wherein the bias mechanism 36 is positioned between the open end 14 an the frame 34. The bias mechanism 38 may be in the form of a spring, coiled compression spring, comprisable material, elastomeric material, polymeric material, resilient material or combinations thereof.

Referring to FIG. 15, yet another embodiment of the present invention is a striker plate 10 having a housing 12 having an open end 14 and one or more housing apertures 32. The recessed area in the frame 34 accommodates the movement of the one or more pins 16. A bias mechanism 38 is positioned to contact the each pin of the one or more pins 16. In one embodiment, the pin of the one or more pins 16 itself may be made or include a spring, coiled compression spring, comprisable material, elastomeric material, polymeric material, resilient material or combinations thereof.

In some embodiments, the housing apertures 32 are separated from other housing apertures 32 by the removal of material of the aperture to extend the aperture to accommodate the shaft 18 thus forming a channel or cavities 36 to allow independent operation of the one or more pins 16. The cavities 36 may include many different structures known to persons of ordinary skill in the art including channels, tunnels, sheaths sleeves and the like.

FIG. 14 shows another embodiment of the striker plate 10 having a first bias mechanisms and a second bias mechanisms 38. The first bias mechanism 38 is positioned to contact the first end 22 of the shaft 18 and the frame 34. The first bias mechanism 38 is held in position due to the restricted movement of the first bias mechanism 38 caused by the enlarged portion of first end 22 and the frame 34, wherein the first bias mechanism 38 is positioned between the open end 14 an the frame 34. A second bias mechanism 38 is positioned to contact the retaining mechanism 26 of the second end 24 of the shaft 18. The bias mechanism 38 is fitted into the cavities 36 of the frame 34 so that the bias mechanism 38 contacts the retaining mechanism 26 of the second end 24 of the shaft 18.

Other embodiments are contemplated that include a bias mechanism 38 that does not have dividers or cavities to separate the individual bias mechanism 38 and/or the one or more pins 16. Additionally, the present invention may use different combinations of bias mechanisms 38 and compression rates, including multiple bias mechanisms 38 in concentric arrangements or in sequential arrangements. The bias mechanism 38 may be in the form of a spring, coiled compression spring, comprisable material, elastomeric material, polymeric material, resilient material or combinations thereof. The bias mechanism 38 may also be incorporated in or on the pin. This may be accomplished through inserting a bias mechanism 38 into a hollow pin which is than positioned through the housing aperture 32 and onto an inserting member (not shown) incorporated into the housing 30, wherein the bias mechanism 38 is compressed against the inserting member (not shown) within the hollow pin.

One embodiment of the present invention of the present invention includes a striker plate 10 including a housing 12 having an internal region 30 and an open end 14 exposing one or more pins 16. The one or more pins 16 are independently slidably positioned to penetrate within the housing 12. Each pin of the one or more pins 16 has a shaft 18 having a middle portion 20 and a first end 22 and a second end 24, wherein the length of the shaft 18 is about 1.25 inches. The first end 22 of the one or more pins 16 extends to the open end 14. While the middle portion 20 of the shaft 18 extends into the internal region 30 and through housing aperture 32, which is about the size of the middle portion 20. The second end 24 of the shaft 18 extends into the internal region 30 of the housing 12 and has a metal cap 26, which has a diameter greater than the diameter of the housing aperture 32, located thereon. The metal cap 26 serves to retain the second end 24 of the shaft 18 on one side of the frame 34 through having a diameter larger than the housing aperture 32, whereby the second end 24 cannot pass through the housing aperture 32. The frame 34 is constructed from a composite material having housing aperture 32 extending through frame 34 a sufficient distance to accommodate the shaft 18. In some embodiments, this may be created through drilling, etching, molding or combinations thereof. The one or more housing apertures 32 receive the corresponding one or more pins 16 allowing the one or more pins 16 to be arranged in a closely packed pattern, whereby each pin of the one or more pins 16 is separated and may move independently of each other pin in the one or more pins 16. The housing aperture 32 is used to isolate the interaction of the individual pins of the one or more pins 16. A spring 38 is positioned to contact metal cap 26 of each pin of the one or more pins 16. The spring 38 is fitted into the cavities 36 of the frame 34 so that the spring 38 contacts the metal cap 26 of the second end 24 of each of the one or more pins 16.

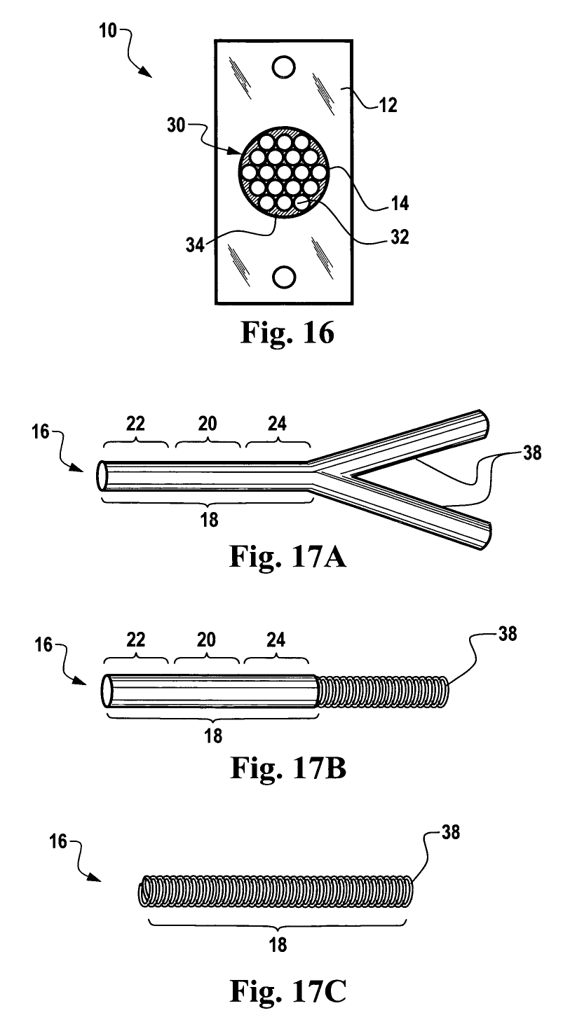

FIG. 16 is a front view of the striker plate 10 including the housing 12 having one or more housing aperture 32. The housing 12 may have housing aperture 32 that extend through housing 12 a sufficient distance to accommodate the one or more pins 16. In some embodiments, this may be created through drilling, etching, molding or combinations thereof. The one or more housing apertures 32 are arranged in a closely packed pattern and designed to receive the corresponding one or more pins (not shown), whereby each pin of the one or more pins (not shown) is separated and may move independently of each other pin in the one or more pins (not shown). The housing aperture 32 is used to isolate the interaction of the individual pins of the one or more pins (not shown).

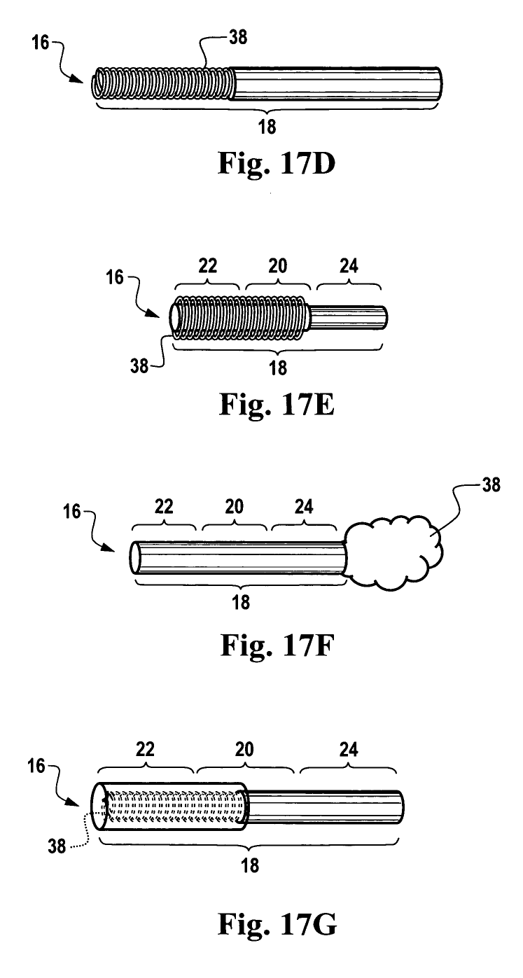

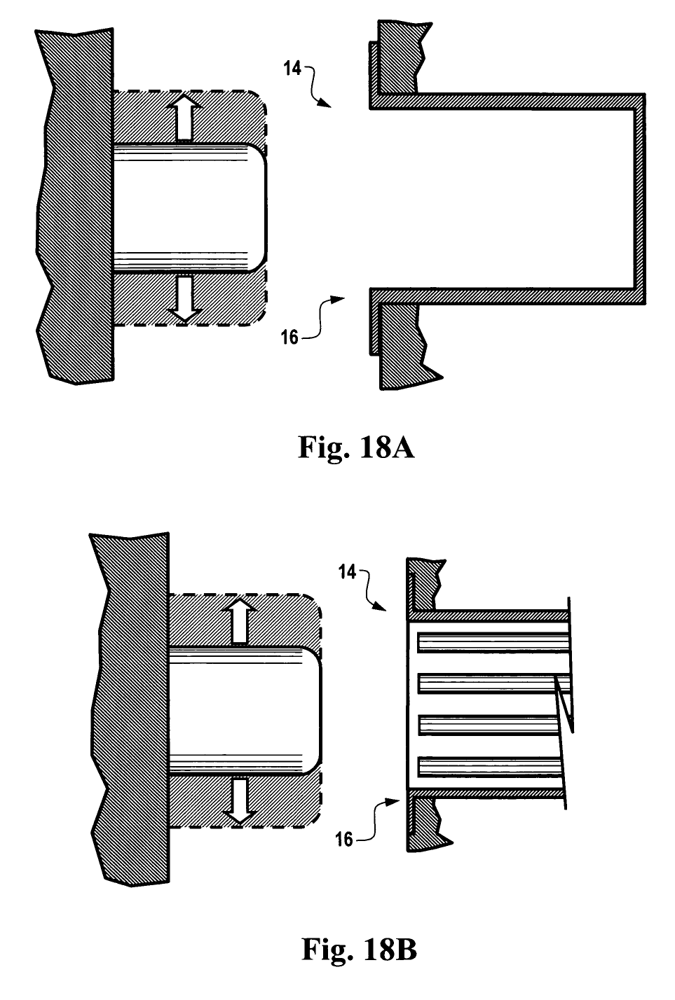

With reference to FIGS. 17a-g are side views of different embodiments of a portion of the apparatus 10 shown in FIG. 1. FIGS. 17a-g are different embodiments of representative pins of one of the one or more pins 16 coupled to bias mechanism 38 of a striker plate (not shown). Each of the one or more pins 16 includes a shaft 18 having a middle portion 20 and a first end 22 and a second end 24. The second end 24 may have a retaining mechanism 26. In some embodiments, each pin of the one or more pins 16 may be coupled to a bias mechanism 38 having a comprisable material, elastomeric material, polymeric material, resilient material or combinations thereof, e.g., FIGS. 17a and 17f. Whereas, other embodiments, may couple each pin of the one or more pins 16 to a bias mechanism 38 employing a spring, coiled spring or compression spring as a bias mechanism 38, e.g., FIGS. 17b, 17c, 17d and 17g. While still other embodiments may, use each pin of the one or more pins 16 coupled to a bias mechanism 38 that uses a combination of a spring and a comprisable material, elastomeric material, polymeric material or resilient material, e.g., FIG. 17e. Additionally, the striker plate 10 may use a combination of different pins and biasing mechanisms in a single unit. FIG. 18 is a side view of a striker plate in use. FIG. 18a demonstrates the position of the throw bolt and the conventional striker plate. In response to movement of the door, doorframe, foundation or combinations thereof, the throw bolt may be at a position higher or lower than the opening in the conventional striker plate. This movement results in misalignment of the relatively small hole of the striker plate and the door latch and/or the dead bolt latch. The misalignment often causes the door to be difficult or even impossible to secure.

FIG. 18b demonstrates the position of the throw bolt and one embodiment of the striker plate 10 including a housing 12 having an internal region 30 and an open end 14 exposing one or more pins 16. In response to movement of the door, doorframe, foundation or combinations thereof, the throw bolt may be at a different position. The different positions of the throw bolt may be accommodated within the housing 12 and the throw bolt would contact one or more of the pins 16. Therefore, allowing the door to be secured.

The striker plate 10, the housing 12, the internal region 30 and the one or more pins 16 may individually be constructed entirely or in part from metals, alloys, plastics, composites, coatings or other suitable materials or combinations thereof. Common materials include steel, chromolly, iron, stainless steel, brass, gold, silver, zinc, copper, nickel, titanium, aluminum, of a mixture including chromolly coated steel. Furthermore, the present invention may be coated, plated, finished or textured as desired.

In addition, studies have shown that a contributing factor to lock failure is the partial extension of the throw bolt. The present invention may include an indicator that reports the extension of the throw bolt. In operation, the throw bolt when fully engaged will result in a connection being made that triggers the indicator. Alternatively, the indicator could be active until the throw bolt is fully engaged wherein the connection being made deactivates the indicator. In some embodiments, the indicator is a visible indicator (e.g., light, bar, etc.) and in other embodiments the indicator is an audible indicator (e.g., a buzz, a click, a hum, a noise, a specific recording, a bark, a growl or other sound). To accomplish this, the present invention may incorporate an indicator (e.g., LED, bulb or other indicator known to the skilled artisan) in communication with a power source (e.g., a battery, an internal source, an external source or both) into the present invention. Alternatively, the present invention may incorporate an audible indicator device, e.g., buzzer, speaker, clicker, or other indicator known to the skilled artisan in to the present invention. The present invention may also include both indicators. Furthermore, the present invention may connect to an electrical connection to trigger an alarm, camera, microphone or other device. For example, when the throw bolt is fully engaged the alarm is activated. Alternatively, when the throw bolt is not fully engaged a camera is activated. The present invention may also include an indicator device that is mechanical in nature and not requiring a power source. For example as the throw bolt is fully engaged the movement will cause the indicator device to click, pop or chime. This type of device is well known in the art.

The present invention includes a striker plate housing having an opening and one or more pins positioned slidably and toward the opening of the striker plate housing. Each of the one or more pins include an elongated middle portion and a first and second end. The one or more retaining mechanisms are positioned at a first end, a second end, in the middle portion, or combinations thereof, of each of the one or more pins. The one or more pins are packed adjacently, whereby force is transmitted laterally among the adjacent pins.

The one or more biasing mechanisms in contact with each pin of the one or more pins for biasing each of the one or more pins toward the opening to conform to the shape of a throw bolt inserted into the opening. The one or more biasing mechanisms include one or more coiled compression springs.

The present invention includes a method of making a self-adjusting striker plate. The method includes creating an opening in a striker plate housing and creating one or more holes within the opening in a striker plate housing. The method includes positioning one or more pins slidably and toward the opening of the striker plate housing, wherein each of the one or more pins are arranged generally parallel to each other. The method includes contacting the one or more pins with one or more biasing mechanism for biasing each of the one or more pins toward the opening of the striker plate housing, wherein the one or more biasing mechanism comprises one or more coiled compression springs.

The present invention also includes a method of securing a door by positioning a striker plate housing adjacent to a throw bolt. The striker plate housing includes an opening, one or more pins positioned slidably and toward the opening of the striker plate housing. Each of the one or more pins include an elongated middle portion and a first and second end. One or more retaining mechanisms are positioned at a first end, a second end, in the middle portion, or combinations thereof, of each of the one or more pins and the one or more pins are packed adjacently. Therefore, force is transmitted laterally among the adjacent pins one or more biasing mechanisms in contact with each pin of the one or more pins for biasing each of the one or more pins toward the opening to conform to the shape of a throw bolt inserted into the opening. The one or more biasing mechanism include one or more coiled compression springs. The method includes inserting the throw bolt into the striker plate housing, wherein at least a portion of the one or more pins are depressed, whereby the throw bolt is retained.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A striker plate comprising:
a striker plate housing comprising at least one opening;
one or more pins positioned slidably and toward the opening of the striker plate housing; and
a biasing mechanism in contact with the one or more pins for biasing each of the one or more pins toward the opening to conform to the shape of a throw bolt inserted into the opening.

2. The striker plate of claim 1, wherein the throw bolt inserted into the opening comprises a throw bolt, dead bolt, circular bolt, dustless bolt, rod bolt, gate bolt, pin bolt, slide bolt, peg, rod, nail, pin, bolt array, pin array, array or a bolt.

3. The striker plate of claim 1, further comprising a flange surrounding the opening for attaching the striker plate housing to a door jam.

4. The striker plate of claim 1, wherein the one or more pins have a cross section that is circular, oval, square, rectangular, triangular, polygonal or combinations thereof.

5. The striker plate of claim 1, wherein the housing is sized to accommodate one or more throw bolts.

6. The striker plate of claim 1, wherein the opening is generally circular, oval, square, rectangular, triangular, polygonal or combination thereof.

7. The striker plate of claim 1, wherein the striker plate housing further comprises one or more biasing mechanisms for each pin.

8. The striker plate of claim 1, wherein the striker plate housing comprises one or more individual cavities for each biasing mechanism for each pin.

9. The striker plate of claim 1, wherein each of the one or more pins are arranged generally parallel to each other.

10. The striker plate of claim 1, wherein the one or more pins are packed adjacently, whereby force is transmitted laterally among the adjacent pins through the one or more pins.

11. The striker plate of claim 1, wherein the one or more pins extend toward the opening at an angle of between about 0 to 90 degrees.

12. The striker plate of claim 1, wherein each of the one or more pins comprises an elongated middle portion and a first and second end, wherein one or more retaining mechanisms is positioned at a first end, a second end, in the middle portion, or combinations thereof, of each of the one or more pins.

13. The striker plate of claim 12, wherein the striker plate housing comprises cavities extending from each of the at least one opening and wherein the bias mechanism is positioned between the one or more retaining mechanism portioned at one end of each of the one or more pins and the end of the cavities.

14. The striker plate of claim 1, wherein the one or more pins comprise a texture to increase friction.

15. The striker plate of claim 1, wherein the biasing mechanism comprises a coiled compression spring.

16. The striker plate of claim 1, wherein the biasing mechanism comprises a coiled compression spring surrounding each of the one or more pins.

17. The striker plate of claim 1, wherein the biasing mechanism includes a compressible medium, an elastomeric medium, a resilient medium or combinations thereof.

18. The striker plate of claim 1, further comprising a mounting flange, wherein the mounting flange is in contact with the striker plate housing and is adapted to fit a doorjam and extend over at least a portion of the interior wall, exterior wall or both.

19. The striker plate of claim 1, further comprising an indicator device connected to the striker plate housing, whereby the position of the one or more pins is indicated by the indicator device.

20. The striker plate of claim 19, wherein the indicator device comprises a speaker, a buzzer, a LED, a bulb, a camera, an alarm or combinations thereof.

21. A method of securing a door comprising the steps of:
positioning a striker plate housing adjacent to a throw bolt, wherein the striker plate housing comprising at least one opening, one or more pins positioned slidably and toward the at least one opening of the striker plate housing and a biasing mechanism in contact with the one or more pins for biasing each of the one or more pins toward the at least one opening to conform to the shape of a throw bolt inserted into the at least one opening; and
inserting the throw bolt into the striker plate housing, wherein at least a portion of the one or more pins are depressed, whereby the throw bolt is retained.

22. The method of claim 21, wherein the striker plate housing is adapted to contact one or more throw bolts.

23. The method of claim 21, wherein the throw bolt inserted into the at least one opening comprises a throw bolt, dead bolt, circular bolt, dustless bolt, rod bolt, gate bolt, pin bolt, slide bolt, peg, rod, nail, pin, bolt array, pin array, array or a bolt.

24. The method of claim 21, wherein the biasing mechanism includes a compressible medium, an elastomeric medium, a resilient medium or combinations thereof.

25. The method of claim 21, wherein the biasing mechanism includes a coiled compression spring.

26. The method of claim 21, wherein each of the one or more pins comprises an elongated middle portion and a first and second end, wherein one or more retaining mechanisms is positioned at a first end, a second end, in the middle portion, or combinations thereof, of each of the one or more pins.

27. A method of making a self-adjusting striker plate comprising the steps of:
creating one or more holes in a striker plate housing;
positioning one or more pins slidably and toward the opening of the striker plate housing; and
contacting the one or more pins with a biasing mechanism for biasing each of the one or more pins toward the opening of the striker plate housing.

28. The method of claim 27, wherein the biasing mechanism includes a coiled compression spring.

29. The method of claim 27, wherein the biasing mechanism is disposed on or about each of the one or more pins.

30. The method of claim 27, wherein the one or more pins comprise a texture to increase friction.

31. The method of claim 27, wherein each of the one or more pins comprises an elongated middle portion and a first and second end, wherein one or more retaining mechanisms is positioned at a first end, a second end, in the middle portion, or combinations thereof, of each of the one or more pins.

32. A striker plate comprising:
a striker plate housing comprising an opening;
one or more pins positioned slidably and toward the opening of the striker plate housing, wherein each of the one or more pins comprises an elongated middle portion and a first and second end, wherein one or more retaining mechanisms is positioned at a first end, a second end, in the middle portion, or combinations thereof, of each of the one or more pins and the one or more pins are packed adjacently, whereby force is transmitted laterally among the adjacent pins; and
one or more biasing mechanisms in contact with each pin of the one or more pins for biasing each of the one or more pins toward the opening to conform to the shape of a throw bolt inserted into the opening, wherein the one or more biasing mechanism comprises one or more coiled compression springs.

33. A method of making a self-adjusting striker plate comprising the steps of:
creating an opening in a striker plate housing;
creating one or more holes within the opening in a striker plate housing;
positioning one or more pins slidably and toward the opening of the striker plate housing, wherein each of the one or more pins are arranged generally parallel to each other; and
contacting the one or more pins with one or more biasing mechanism for biasing each of the one or more pins toward the opening of the striker plate housing, wherein the one or more biasing mechanism comprises one or more coiled compression springs.
